(19) United States
(12) Patent Application Publication
(10) Pub. No.: US 2024/0287643 A1
(43) Pub. Date: Aug. 29, 2024

(54) APPARATUS AND METHOD FOR SELECTIVE REMOVAL OF AT LEAST ONE RARE EARTH ELEMENT

(71) Applicant: THE PENN STATE RESEARCH FOUNDATION, University Park, PA (US)

(72) Inventor: Amir Sheikhi, State College, PA (US)

(21) Appl. No.: 18/568,550

(22) PCT Filed: Jun. 7, 2022
(86) PCT No.: PCT/US2022/032416

§ 371 Date: Dec. 8, 2023

Related U.S. Application Data
(60) Provisional application No. 63/210,186, filed on Jun. 14, 2021.
(60) Provisional application No. 63/212,947, filed on Jun. 21, 2021.

(51) Int. Cl. C22B 3/44; C08B 15/00; C22B 59/00

(52) U.S. Cl. CPC C22B 3/44; C08B 15/00; C22B 59/00

(57) ABSTRACT

A method and apparatus for removal of at least one rare earth element (REE) or at least one pre-selected ion can include forming a hairy nanocellulose (HNC) from a feed, feeding the HNC to a solution including the at least one REE or pre-selected ion to form solid precipitates comprising the at least one REE or pre-selected ion within the solution, and separating the solid precipitates comprising the at least one REE or pre-selected ion from a fluid of the solution.

### CROSS-REFERENCE TO RELATED APPLICATION

The present application claims priority to U.S. Provisional Patent Application No. 63/210,186 filed on Jun. 14, 2021. The entirety of this provisional patent application is incorporated by reference herein.

The present application also claims priority to U.S. Provisional Patent Application No. 63/212,947, filed on Jun. 21, 2021. The entirety of this provisional patent application is also incorporated by reference herein.

### FIELD

The present innovation related to devices and methods for selective removal of at least one rare earth element such as, for example, neodymium (Nd), or other rare earth element.

### BACKGROUND

Neodymium (Nd) is one the most demanded rare earth elements (REE). The demand for Nd has significantly been elevated, e.g., ˜400% increase in the past two decades.

Nd is considered to be an enabling element in NdFeB magnets, one of the strongest permanent magnets in the world. NdFeB magnets are widely used in numerous industries, involving electronic devices, industrial motors, and magnetic resonance imaging (MRI) scanners. These magnets are also the enabling technology for green energy sectors, such as wind turbine generators and solar panels.

### SUMMARY

Nd has been separated from solutions using several techniques, such as solvent extraction, ion exchange, chemical precipitation, and adsorption. Solvent extraction is currently the main commercially available technique; however, it typically lacks high selectivity, is expensive and time consuming, and is not sustainable in the long run as it requires large amounts of toxic organic solvents, negatively impacting the environment.

Cellulose is one of the most abundant biopolymers in the world and is a renewable resource, which may readily be resupplied. It is a polysaccharide, including β(1→4) linked D-glucose units, bearing a large hydroxyl group content and can be a polysaccharide consisting of β(1→4) linked D-glucose units, bearing a large hydroxyl group content. The large hydroxyl group content of cellulose can enable chemical modifications for the removal of target adsorbates.

Despite several advantages of cellulose-based adsorbents, including sustainability, biorenewability, and cost effectiveness, we have determined that the inaccessibility of inner crystalline layers of cellulose fibrils and nanocelluloses, such as cellulose nanocrystals (CNCs), has limited their functional group density, hindering the development of high-capacity, rapid REE adsorbents.

To increase the accessibility of functional groups, cellulose fibrils can be oxidized at amorphous regions, yielding hairy nanocelluloses, comprising hairy cellulose nanocrystals and solubilized cellulose chains, which may be separated from each other using a poor solvent, such as ethanol. The structure of hairy cellulose nanocrystals is fundamentally different than conventional nanocelluloses, such as CNCs and cellulose nanofibrils (CNFs). These nanocelluloses have a crystalline body similar to the conventional CNCs, but these crystalline bodies are sandwiched between layers of highly functionalized amorphous cellulose chains protruding from each end, introducing about one order of magnitude higher charge density than conventional nanocelluloses.

We determined that cellulose fibrils can be converted into anionic hairy nanocellulose (AHNC) with highly dicarboxylated nanoscale building blocks, anionic hairy cellulose nanocrystals (AHCNC) mixed with solubilized dicarboxylated cellulose (DCC) chains, engineered to remove Nd ions from aqueous media. At least parameters that include contact time, initial Nd ion (e.g. Nd³⁺) concentration, ionic strength, pH, and temperature, can have an effect on the removal of Nd ions (e.g. Nd³⁺).

Embodiments of our process, method, and apparatus for recovery of at least one REE can include Nd ions (e.g. Nd³⁺ ions) in a mixed solution (e.g. an Nd³⁺—Fe²⁺ solution) being recovered from NdFeB magnet leachates, other type of magnet disposal or magnet recovery systems, or any other disposal system or recovery system, such as an electronic waste (e-waste) disposal system, etc. The removal of the Nd ions can facilitate recovery and recycling of the Nd for reuse of the Nd in new magnets or other applications. Embodiments of the process, method, and apparatus can also be designed for utilization with other REEs (e.g. Europium (Eu), Terbium (Tb), Dysprosium (Dy) and Yttrium (Y), etc.).

Embodiments can utilize other anionic, electrically neutral, or cationic functional groups and proteins so that such elements can be decorated on the hairy nanocelluloses rendering them suitable for other REEs, precious metals, lithium, or other elements. For example, some embodiments can be configured so that cellulose fibrils can be converted into hairy nanocellulose (HNC) with nanoscale building blocks and hairy cellulose nanocrystals (HCNC) mixed with electrically neutral, or cationic functional groups and proteins engineered to remove one or more pre-selected ions from aqueous media. At least parameters that include contact time, initial ion concentration, ionic strength, pH, and temperature, can have an effect on the removal of the one or more pre-selected ions.

Embodiments can include a method for removal of at least one rare earth element (REE) that include forming anionic hairy nanocellulose (AHNC) from a feed, feeding the AHNC to a solution including the at least one REE to form solid precipitates comprising the at least one REE within the solution, and separating the solid precipitates comprising the at least one REE from a fluid of the solution.

The at least one REE can include neodymium (Nd) and/or other elements. For example, the REE can include only Nd, lithium (Li), only Li, or a combination of one or more RRE. As nother example, the at least one REE can include Eu, Tb, Dy, Y, gold, silver, or platinum. A combination of at least one REE can include, for example, a combination of two or more of: Nd, Li, a rare earth element, Eu, Tb, Dy, Y, gold, silver, and platinum.

The forming of AHNC from the feed can be performed by forming dialdehyde modified cellulose (DAMC) from the feed (when the feed is a cellulose feed, for example). The forming of AHNC can also include forming the AHNC from the formed DAMC.

The forming of the DAMC from the feed can include mixing NaCl and NaIO₄ with a pulp feed material comprising cellulose to form a mixture and agitating the mixture for a pre-selected DAMC formation period and adding a quenching agent to the mixture after the pre-selected DAMC formation of time. The quenching agent can include ethylene glycol in some implementations.

In some aspects, the forming the AHNC from the formed DAMC can include agitating a mixture of DAMC slurry having solid DAMC, milli-Q water, NaCl, NaClO₂, and H₂O₂ for a pre-selected AHNC formation period a pre-selected AHNC formation temperature. The mixture of DAMC slurry can have solid DAMC, milli-Q water, NaCl, NaClO₂, and H₂O₂ that is maintained at a pH 5 for at least a pre-selected pH maintenance period of time via the intermittent addition of a base. The base can be NaOH or any other base.

Embodiments of the method can also include separating non-disintegrated fibers from the mixture of DAMC slurry having solid DAMC, milli-Q water, NaCl, NaClO₂, and H₂O₂ after the pre-selected AHNC formation period. The separating of the non-disintegrated fibers from the mixture of DAMC slurry having solid DAMC, milli-Q water, NaCl, NaClO₂, and H₂O₂ can include use of at least one centrifuge.

A precipitating agent can be added to precipitate AHNC from the mixture of DAMC slurry having solid DAMC, milli-Q water, NaCl, NaClO₂, and H₂O₂. The precipitated AHNC can include anionic hairy cellulose nanocrystals (AHCNC) mixed with solubilized dicarboxylated cellulose (DCC).

Embodiments of the method can also include other steps. For example, the method can include washing and/or filtering the DAMC after the pre-selected DAMC formation period of time.

As another example, the method can also include purifying the formed AHNC for a pre-selected purification time period. The pre-selected purification time can be at least 2 minutes or at least 1 day.

An apparatus for selective removal of at least one rare earth element (REE) is also provided. Embodiments of the apparatus can be configured to utilize an embodiment of the method of selective removal of at least one REE. Embodiments of the apparatus can include an REE recovery vessel, a source of anionic hairy nanocellulose (AHNC) configured to feed AHNC or its components to the REE recovery vessel to form a solid AHNC-REE precipitate within a fluid within the REE recovery vessel that includes the at least one REE, and a separator connected to the REE recovery vessel to receive the fluid having the solid AHNC-REE precipitate to separate the solid AHNC-REE precipitate from the fluid.

The separator can include at least one centrifuge or be configured to perform separation via sedimentation or addition of a flocculant.

The apparatus can also include an AHNC production system configured to form AHNC from a feed material. The feed material can include a cellulose feed or other type of suitable feed (e.g. cellulose material, a biopolymer material, chitin, chitosan, alginate, lignin, or hyaluronic acid). The AHNC production system can be the source of AHNC or can be connected to the source of AHNC for feeding AHNC to the source of AHNC.

A method for removal of at least one pre-selected ion (P-SI) is also provided. Embodiments of the method can include forming hairy nanocellulose (HNC) from a feed, feeding the HNC to a solution including the at least one P-SI to form solid precipitates comprising the at least one P-SI within the solution, and separating the solid precipitates comprising the at least one P-SI from a fluid of the solution.

The feed can include a cellulose material, a biopolymer material, chitin, chitosan, alginate, lignin, or hyaluronic acid.

The method can also include other steps. For example, the method can also include mixing anionic, electrically neutral, or cationic functional groups and/or proteins with the HNC for being added to the HNC prior to the HNC being fed to the solution for removal of the at least one P-SI.

The at least one pre-selected ion can be a suitable ion for a particular implementation. For instance, the at least one pre-selected ion can be Nd, Li, a rare earth element, Eu, Tb, Dy, Y, gold, silver, platinum, or a combination thereof. For instance, the ion can be an Nd ion or an Li ion.

An apparatus for selective removal of at least one pre-selected ion (P-SI) is also provided. An embodiment of the apparatus can utilize an embodiment of the above discussed methods, for example. Embodiments of the apparatus can include a P-SI recovery vessel, a source of hairy nanocellulose (HNC) configured to feed HNC or its components to the P-SI recovery vessel to form a solid HNC-P-SI precipitate within a fluid within the P-SI recovery vessel that includes the at least one P-SI, and a separator connected to the P-SI recovery vessel to receive the fluid having the solid HNC-REE precipitate to separate the solid HNC-P-SI precipitate from the fluid.

In some embodiments, the HNC can be an anionic HNC (AHNC) and the apparatus can also include an AHNC production system configured to form AHNC from a feed material.

The feed material can include a suitable feed. For example, the fed material can include a cellulose material, a biopolymer material, chitin, chitosan, alginate, lignin, or hyaluronic acid.

The at least one pre-selected ion can be a suitable ion. For example, the pre-selected ion can be Nd, Li, a rare earth element, Eu, Tb, Dy, Y, gold, silver, platinum, or a combination thereof. For instance, the ion can be an Nd ion or an Li ion.

Other details, objects, and advantages of the invention will become apparent as the following description of certain present preferred embodiments thereof and certain present preferred methods of practicing the same proceeds.

### BRIEF DESCRIPTION OF THE DRAWINGS

Exemplary embodiments of our process, method, and apparatus for recovery of at least one REE, and methods of making and using the same are shown in the accompanying drawings. It should be appreciated that like reference numbers used in the drawings may identify like components.

FIG. 1 is schematic of an exemplary process for anionic hairy nanocellulose (AHNC) synthesis from cellulose pulp. The AHNC may also be prepared from other biomass sources, such as, for example, cotton or other biomass source.

FIG. 2 is a series of images illustrating starting material (cellulose pulp sheet), intermediate (wet dialdehyde modified cellulose, DAMC), and products (AHNC) that include anionic hairy cellulose nanocrystals (AHCNC) and dicarboxylated cellulose (DCC) that can be utilized in the exemplary process shown in FIG. 1.

FIG. 3 is a graph illustrating DAMC aldehyde content measurement by hydroxylamine hydrochloride titration method.

FIG. 4 is a graph illustrating ethanol-mediated incremental precipitation of AHNC (initial concentration ˜6333 ppm), yielding AHCNC and DCC. The AHNC is a product of the controlled chlorite oxidation of DAMC after dialysis against “milli-Q water.” which is water purified using a Millipore Milli-Q lab water system. The amount of ethanol that is utilized can depend on the cellulose source.

FIG. 5 is a graph illustrating conductometric titration curve of AHNC for carboxylate content measurement.

FIG. 6 is a graph illustrating a pH titration curve of AHNC, obtained simultaneously with the conductometric titration of AHNC.

FIG. 7 is an AFM image of AHNC, showing the crystalline body of AHCNC.

FIG. 8 is a schematic view of an exemplary neodymium removal process using AHNC.

FIG. 9 is a picture of different vessels illustrating AHNC-Nd precipitate formation after centrifugation at different Nd³⁺ initial concentration (C₀).

FIG. 10 is a graph illustrating the effect of contact time on AHNC mediated removal of Nd³⁺ (initial concentration, C₀=200 ppm). The centrifugation time was 5 min, which is not included in the contact time.

FIG. 11 is a graph illustrating Nd³⁺ maximum removal capacity of AHNC (qₑ) versus Nd³⁺ initial concentration (C₀). In this experiment of FIG. 11, the total volume=7 mL, and mass of AHNC m=3.5 mg.

FIG. 12 is a graph illustrating Nd³⁺ removal percentage versus initial concentration, C₀.

FIG. 13 is a graph illustrating hydrodynamic size of AHNC-Nd aggregates in the supernatant versus C₀. Total volume=1.5 mL.

FIG. 14 is a graph illustrating FT-IR spectra of AHNC and AHNC-Nd precipitate. In all experiments, AHNC concentration=500 ppm.

FIG. 15 is a schematic view of an exemplary process in which AHNC-Nd precipitation occurs after calcium ion addition at low concentrations of Nd³⁺ (C₀=10 and 50 ppm).

FIG. 16 is a schematic view of an exemplary process of a hypothesized mechanism of Ca²⁺-mediated aggregation of otherwise stable AHNC-Nd colloids at initial Nd³⁺ concentrations below the stochiometric ratio (C₀<140 ppm).

FIG. 17 is a graph illustrating Nd³⁺ removal capacity of AHNC versus complementary calcium ion concentrations (calcium is added last) in an exemplary embodiment of our process.

FIG. 18 is a graph illustrating Nd³⁺ removal percentage versus calcium ion concentration in an exemplary embodiment of our process. In the measurements shown in FIG. 18, the AHNC concentration=500 ppm, and total volume=7 mL.

FIG. 19 is a graph illustrating the effect of monovalent (Na⁺) and divalent (Ca²⁺) cations on the removal capacity of Nd³⁺ by AHNC in an exemplary embodiment of our process. In the measurements shown in FIG. 19, the AHNC concentration=500 ppm, and total volume=7 mL.

FIG. 20 is a graph illustrating a measured effect of pH on the AHNC-mediated Nd³⁺ removal capacity in an exemplar embodiment of our process. In the measurements shown in FIG. 20, the AHNC concentration=500 ppm, and total volume=7 mL.

FIG. 21 is a graph illustrating an effect of temperature on the AHNC-mediated Nd³⁺ removal capacity in an exemplary embodiment of our process. In the measurements shown in FIG. 21, the AHNC concentration=500 ppm, and total volume=7 mL.

FIG. 22 is a graph illustrating an effect of Fe²⁺ on the Nd³⁺ removal capacity of AHNC in an embodiment of our process. For this experiment, AHNC concentration=500 ppm, initial Nd³⁺ concentration C₀=200 ppm, and total volume was 1 mL. In the measurements shown in FIG. 22, the AHNC concentration=500 ppm, and total volume=1 mL.

FIG. 23 is a graph illustrating Fe²⁺ removal capacity of AHNC in the absence and presence of Nd³⁺ ions. In the measurements shown in FIG. 23, the AHNC concentration=500 ppm, and total volume=1 mL.

FIG. 24 is a block diagram of an exemplary embodiment of an apparatus for selective removal of at least one REE. Embodiments of the apparatus can be utilized for magnet recycling systems, magnet waste disposal systems, electronic waste (e-waste) disposal systems, e-waste recycling systems, acid mine drainage applications, or other applications.

### DETAILED DESCRIPTION OF PRESENT PREFERRED EMBODIMENTS

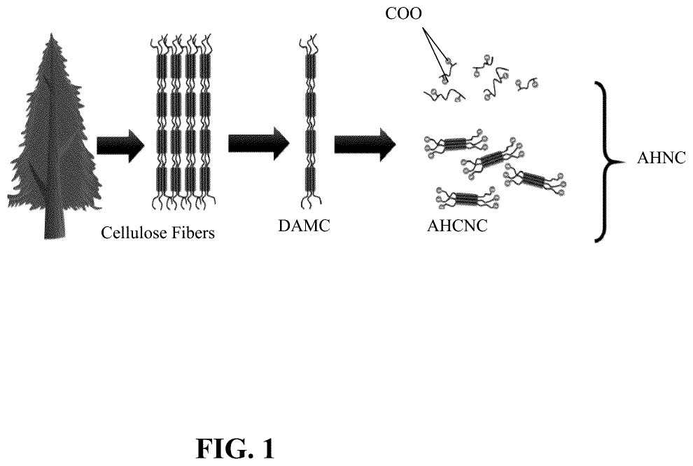

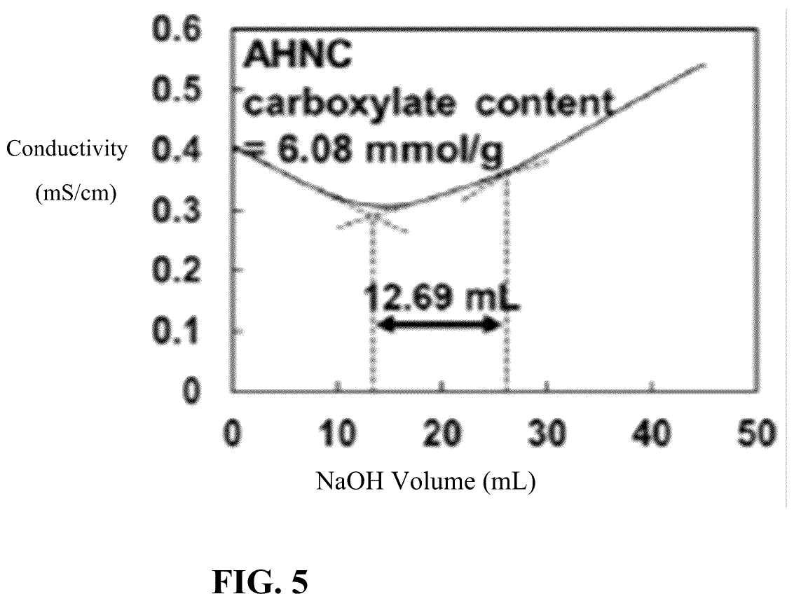

Referring to FIGS. 1-24, embodiments of methods, processes and apparatuses for removal of at least one rare earth element (REE) from a fluid (e.g. a liquid solution having the at least one REE mixed therein or entrained therein, a gas having particulates entrained therein that include at least one REE, etc.). Embodiments can utilize a source material for forming an adsorption media. The source material can be processed to form the adsorption media for removal of the at least one REE from the fluid. The source material can be based on cellulose or other biopolymers, such as chitin, chitosan, alginate, lignin, hyaluronic acid, etc. The adsorption media can be structured as a filter to filter out the at least one REE, or can be structured as another type of separation structure. The separation structure, adsorption media, or filter having the at least one REE separated from the fluid can then be processed to extract the at least one REE for providing the REE for further processing (e.g. further refinement, formation of the at least one REE into a structure, shipping the collected REE to a customer or distributor, etc.).

### Exemplary Source Material Processing to Form AHNC

In some exemplary embodiments, the source material can include wood or a material formed from wood or any other biomass, such as cotton, etc. For instance, the source material can include Q-90 bleached softwood pulp sheets from Domtar, Canada. Other embodiments can utilize different types of pulp sheets, wood pulp sheets, or other type of pulp material.

In some embodiments, Q-90 softwood pulp sheets (or other type of wood pulp sheets) can be into sheets having a pre-selected size. The sheets can then be soaked in water for ˜24 h, mechanically disintegrated using a blender or other agitator mechanism, and then filtered to produce a wet pulp slurry. To convert cellulose fibers of the wet pulp slurry to dialdehyde modified cellulose (DAMC), the wet pulp slurry containing milli-Q water, NaCl, and NaIO₄ can be mixed together and continuously stirred for a pre-selected period of time (e.g. 96 hours) at room temperature in a covered vessel to prevent the light-mediated deactivation of periodate. The reaction will also work without NaCl. It should be understood that the “milli-Q water” is water purified using a Millipore Milli-Q lab water system.

To stop the reaction, ethylene glycol can be added to quench the unreacted periodate. DAMC can then be washed with milli-Q water one or more times and then be filtered. Next, the aldehyde groups of DAMC can be converted to dicarboxylate groups, yielding AHNC. To this end, DAMC slurry containing solid DAMC, milli-Q water, NaCl, NaClO₂, and H₂O₂ can be mixed together and continuously stirred for a pre-selected period of time (e.g. 24 hours) at room temperature. Other oxidizing agents, such as ammonium persulfate (APS), may also be used instead of NaClO₂ or in combination with NaClO₂. The solution can be maintained at pH 5 for at least a pre-selected period of time (e.g., 5 hours) by the intermittent addition of NaOH. Then, the solution can be centrifuged at a pre-selected centrifuge setting (e.g. 27,000 times gravity (or “×g”)) for a centrifugal period of time to separate the non-disintegrated fibers. Ethanol can then added to the supernatant to precipitate AHNC, separated by centrifugation at another pre-selected centrifuge setting (e.g. 3000×g) for another centrifugal period of time. The gel-like AHNC obtained from precipitation of the AHNC can be include AHCNC and DCC. This material can then be redispersed in milli-Q water and purified by dialysis for a pre-selected purification time period (e.g. at least 4 days, at least 5 days, more than 3 days, etc.) to remove salt and any other chemicals. The purification time can vary from a few minutes (e.g. at least 2 minutes) to several weeks depending on the pulp source and amount, reaction scale, and reactant concentrations.

As another example, 5 g of Q-90 softwood pulp sheets can be cut into 2×2 cm thin sheets, soaked in water for ˜24 h, mechanically disintegrated using a fruit blender or other agitation mechanism, and vacuum filtered, producing a wet pulp slurry for a lab-scale experimental application. To convert cellulose fibers to dialdehyde modified cellulose (DAMC), the wet pulp slurry containing 332.5 mL of milli-Q water, 19.5 g of NaCl, and 6.67 g of NaIO₄ was continuously stirred for 96 h at room temperature in a beaker covered with an aluminum foil to prevent the light-mediated deactivation of periodate. To stop the reaction, 3.75 mL of ethylene glycol was added to quench the unreacted periodate. DAMC was washed with milli-Q water 5 times and vacuum filtered. Next, the aldehyde groups of DAMC were converted to dicarboxylate groups, yielding AHNC. To this end, DAMC slurry containing 5 g of solid DAMC, 250 mL of milli-Q water, 14.65 g of NaCl, 7.05 g of NaClO₂, and 7.05 g of H₂O₂ was continuously stirred for 24 h at room temperature. The solution was maintained at pH 5 for at least 5 h by the intermittent addition of 0.5 M of NaOH. Then, the solution was centrifuged at 27,000×g for 10 min to separate the non-disintegrated fibers. Ethanol was added to the supernatant to precipitate AHNC, separated by centrifugation at 3000×g for 10 min. The gel-like AHNC, made up of AHCNC and DCC, was redispersed in 50 mL of milli-Q water and purified by dialysis (Spectra, M_{W} cutoff=12-14 kDa) for at least 4 days to remove salt and any other chemicals. It should be appreciated that the above example provides exemplary masses, volumes, and times for processing. Other times, masses, volumes, or other parameters can be used in other embodiments (.e.g. industrial sized applications, etc.).

For the examples discussed herein, the neodymium (III) chloride hexahydrate (NdCl₃·6H₂O, 99.9% trace metal basis), sodium chloride (NaCl, >99.5%), sodium (meta)periodate (NaIO₄, >99.0%), sodium chlorite (NaClO₂, 80%), hydrogen peroxide (H₂O₂, 30 wt %), sodium hydroxide (NaOH, ACS Reagent >97%), and ethylene glycol (Reagent plus >99%), hydrochloric acid (HCl, ACS reagent, 37%), hydroxylamine hydrochloride (NH₂OH·HCl, Reagent plus 99%), and iron(II) sulfate heptahydrate (FeSO₄·7H₂O, ACS reagent, >99.0%) were purchased from Sigma-Aldrich, USA. Anhydrous ethanol (200 proof) was supplied by KOPTEC, USA.

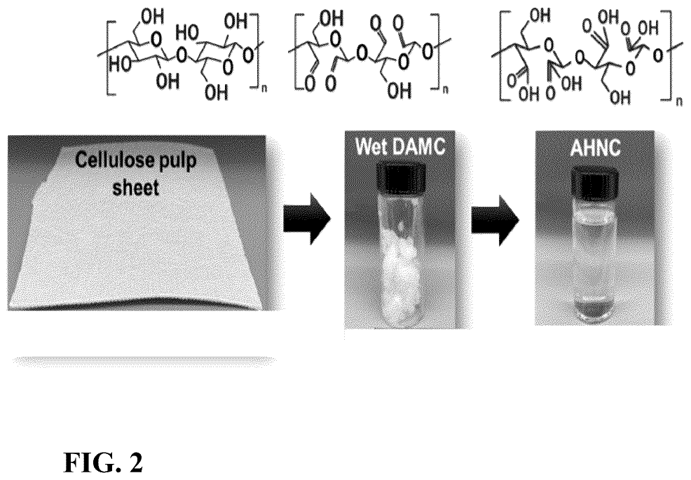

The hierarchical structure of cellulose fibers, fibrils, and an exemplary order of crystalline and amorphous regions in the fibrils are schematically shown in FIG. 1. Through cellulose pulp periodate oxidation at room temperature, cellulose fibrils can be converted to intact DAMC as shown in FIGS. 1 and 2, which can be used as an intermediate to produce AHNC. The conversion of the cellulose fibers to DAMC can be via the conversion process that includes mixing and/or stirring a wet pulp slurry including milli-Q water, 1 NaCl, and NaIO₄ for a DAMC conversion time period (e.g. 96 h) at room temperature in a covered vessel or enclosed vessel. The conversion process can be stopped by adding ethylene glycol to quench the unreacted periodate. The formed DAMC can then be washed and vacuum filtered.

As can be appreciated from the above, the intermediate DAMC can then be converted to AHNC in a DAMC conversion process. For instance, the aldehyde groups of DAMC can be converted to dicarboxylate groups, yielding AHNC. For example, a DAMC slurry of solid DAMC, milli-Q water, NaCl, NaClO₂, and H₂O₂ can be mixed for a DAMC chlorite oxidation time period (e.g. 24 hours) at room temperature. During this time period, the mixture can be continuously stirred. Thereafter, the mixture can be maintained at pre-selected pH level (e.g. a pH of 5) for a maintenance time period (e.g. at least 5 hours) by the intermittent addition of 0.5 M of NaOH. Then, the solution can be centrifuged or filtered to separate the non-disintegrated fibers. Ethanol can be added to the supernatant to precipitate AHNC. The precipitated AHNC (e.g. solid AHNC) can be separated via filtration or other separation process (e.g. by centrifugation) for an AHNC precipitate separation time period. The gel-like AHNC precipitate can include AHCNC and/or DCC, The separated AHNC precipitate can undergo redispersion and purification for a AHNC precipitate purification time period (e.g. at least 1-4 days) to remove salt and any other chemicals. This purified dispersion can be a transparent colloidal dispersion of AHNC that includes AHCNC, also known as electrosterically stabilize nanocellulose crystals (ENCC), and DCC as shown in the examples of FIGS. 1 and 2. In this regard, it should be noted that the chemical structures of DAMC and AHNC shown in FIG. 1 are shown only based on the reacted cellulose units.

We conducted experimentation as discussed below to evaluate embodiments of our REE removal processes and apparatuses to better understand the mechanisms of the embodiments and how embodiments of our REE removal processes and apparatus can compare to conventional processes used for REE removal/recycling.

### Experiments

### Characterization of DAMC And AHNC Formed Therefrom

For the examples discussed here, AHNC and DAMC were formed utilizing this exemplar process:

1. 5 g of Q-90 softwood pulp sheets cut into 2×2 cm thin sheets, soaked in water for ˜24 h, mechanically disintegrated using a fruit blender, and vacuum filtered, producing a wet pulp slurry.

2. To convert cellulose fibers to dialdehyde modified cellulose (DAMC), the wet pulp slurry containing 332.5 mL of milli-Q water, 19.5 g of NaCl, and 6.67 g of NaIO₄ was continuously stirred for 96 h at room temperature in a beaker covered with an aluminum foil to prevent the light-mediated deactivation of periodate. To stop the reaction, 3.75 mL of ethylene glycol was added to quench the unreacted periodate. DAMC formed therefrom was washed with milli-Q water 5 times and vacuum filtered.

3. The aldehyde groups of DAMC were converted to dicarboxylate groups, yielding AHNC. DAMC slurry containing 5 g of solid DAMC, 250 mL of milli-Q water, 14.65 g of NaCl, 7.05 g of NaClO₂, and 7.05 g of H₂O₂ was continuously stirred for 24 h at room temperature. The solution was maintained at pH 5 for at least 5 h by the intermittent addition of 0.5 M of NaOH. Then, the solution was centrifuged at 27,000×g for 10 min to separate the non-disintegrated fibers. Ethanol was added to the supernatant to precipitate AHNC, separated by centrifugation at 3000×g for 10 min. The gel-like AHNC, made up of AHCNC and DCC, was redispersed in 50 mL of milli-Q water and purified by dialysis (Spectra, molecular mass, M_{W}, cutoff=12-14 kilodaltons, kDa) for at least 4 days to remove salt and any other chemicals.

The composition of purified AHNC formed from this process was determined through incremental precipitation with ethanol via which AHCNC was precipitated first, followed by the precipitation of DCC. A total of 20 g of AHCNC dispersion was incrementally precipitated with ethanol (10 wt %) until no further precipitate was seen. For each incremental addition of ethanol, the precipitate was separated by centrifugation at 8500×g, dried at 50° C. for 24 h, and weighed.

To measure the aldehyde content of DAMC formed during the above processing, a known amount of never-dried DAMC (e.g., 0.1 g) was added to 50 mL of milli-Q water, and the solution pH was adjusted to 3.5 using HCl (0.1 M). Then, 10 mL of 5 wt % hydroxylamine hydrochloride was added and continuously stirred for 10 minutes, which decreased pH due to the hydroxylamine-aldehyde reaction, releasing hydrochloric acid. The aldehyde content was measured from titrating the solution by NaOH (10 mM) addition at a rate of 0.1 mL/min using Metrohm 907 Titrando until pH was stabilized at 3.5 (initial pH).

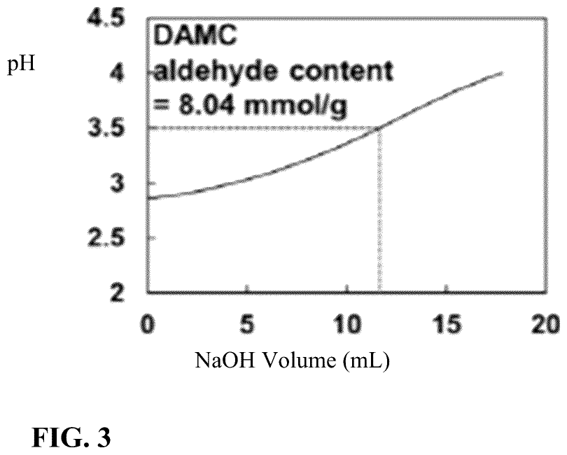

The aldehyde group content of DAMC was determined via the reaction of hydroxylamine hydrochloride with the aldehyde groups in a solution with an initial pH=3.5, releasing hydrochloric acid that decreased pH. The solution was then titrated with a strong base (NaOH), and pH change during titration is shown in FIG. 3. Based on the amount of base used to bring the pH back to the initial pH (3.5), 8.04 mmol of aldehyde per gram of DAMC was calculated. The composition of AHNC suspension was determined through incremental precipitation with a poor solvent, ethanol. The critical concentration at which AHCNC and DCC are no longer stable in the water-ethanol mixture is determined by the Flory-Huggins theory, suggesting that AHCNC phase separates first, followed by DCC precipitation.

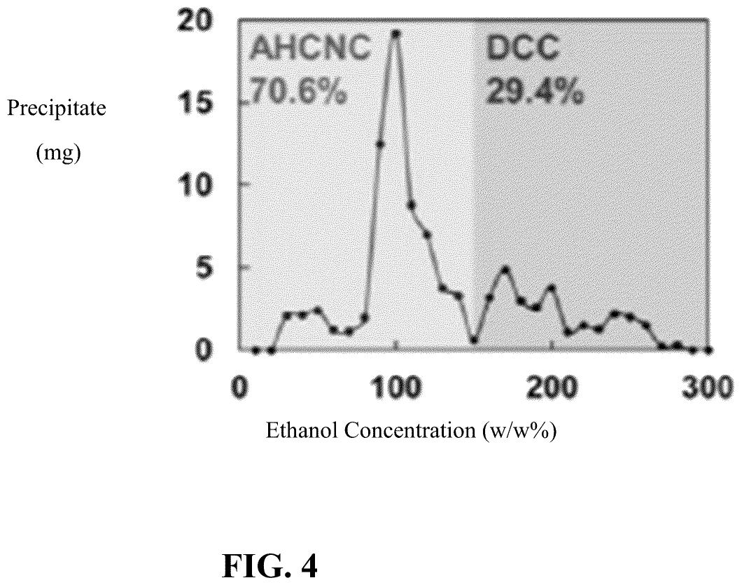

FIG. 4 represents the weight of precipitated AHNC versus the final ethanol concentration in the dispersion. There is a distinct drop in the amount of precipitated AHNC at an ethanol concentration of 150% weight per weight (w/w), showing that all AHCNC precipitated out of the AHNC solution, leaving DCC in the solution. DCC was then separated from solution at about 300% w/w of ethanol. According to the precipitation curve, dialyzed AHNC is composed of ˜70.6% AHCNC and ˜29.4% DCC. This ratio depends on the cellulose source, and any other ratios ranging from 0 to 100% may be used for REE removal.

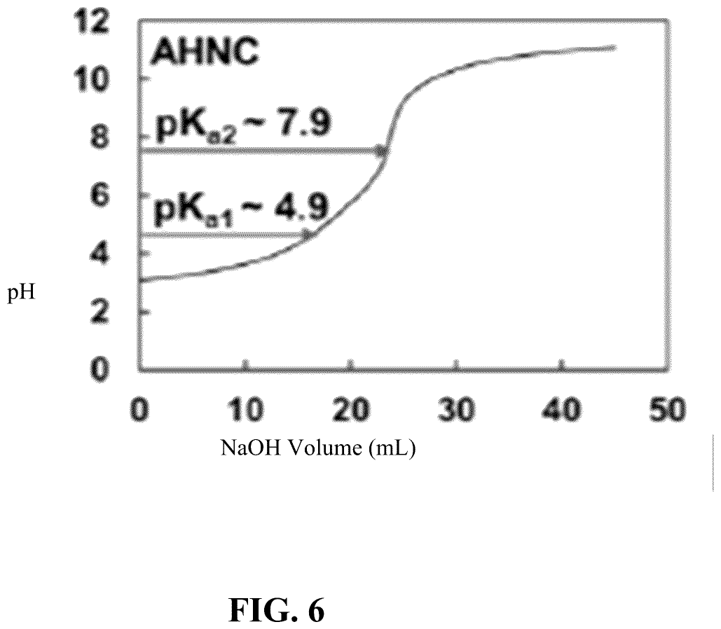

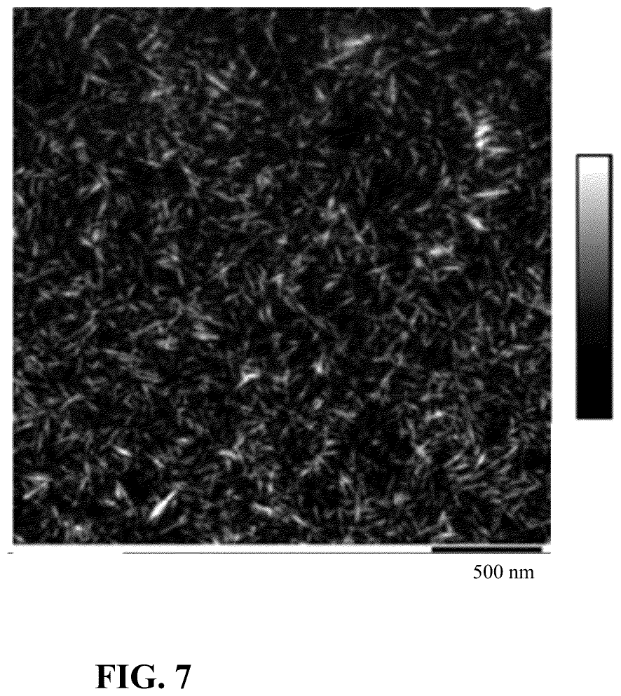

The morphology of the crystalline body of AHCNC was obtained by AFM imaging, shown in FIG. 7. As can be seen in this figure, AHCNC is a rod-like nanoparticle with a length of ˜76±27 nm and a width of ˜14±3 nm. DCC cannot be imaged using AFM. The carboxylate content of AHNC was obtained via conductometric titration (FIG. 6), showing that there is 6.08 mmol of carboxylate group per gram of AHNC. FIG. 6 shows the pH change of AHNC dispersion upon NaOH addition, attesting to two equivalence points, corresponding to the pKₐ of dicarboxylates: pKₐ₁˜4.9 and pKₐ₂˜ 7.9. The pKa values of AHNC are important in determining the effect of pH on the adsorption of Nd³⁺.

The conductometric titration was performed using Methrom 907 Titrando to measure the charge density of AHNC. Purified, never-dried AHNC (containing 0.02 g of solid) was dispersed in 140 mL of milli-Q water. Then, 2 mL of a NaCl solution (20 mM) was added to the dispersion, and the pH was adjusted to 3 using HCl (0.1 M). The solution was titrated with NaOH (10 mM) at 0.1 mL/min increments until the pH reached ˜11. The AHNC charge density was calculated based on the volume of NaOH consumed to neutralize the weak acid, i.e., carboxylate groups.

The morphology of AHCNC was studied using AFM imaging. The sample preparation and imaging parameters included having a freshly cleaved mica disc glued to a magnetic stainless steel disc and coated with 0.1% (mass concentration of the solute in the solution, w/v) polylysine (PLL), to impart positive charges to the mica surface, facilitating the adsorption of negatively charge AHCNC. To this end, the PLL solution was incubated on the mica for 5 min, followed by rinsing the excess solution using milli-Q water. A drop of AHNC with a concentration of 0.1 mg/mL was placed on the mica and incubated for 5 min. The excess AHNC was gently rinsed again with milli-Q water. The sample was air-dried overnight before imaging. The AFM imaging was performed using a silicon nitride probe (Scanasyst-Air) under a tapping mode. The images were processed using the NanoScope Analysis (version 2.0), and the size was measured using Gwyddion (version 2.56). AFM imaging was able to visualize only the crystalline body of the AHCNCs.

### Exemplary Removal of Nd Ions Using AHNC Dispersions

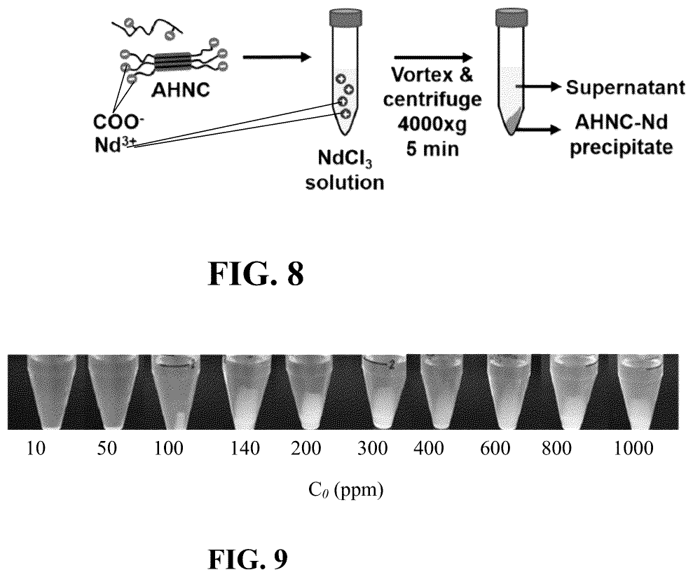

Nd³⁺ removal experiments were conducted by adding AHNC dispersions obtained from the above noted processing of steps 1-3 to form NdCl₃ solutions. FIG. 8 schematically shows an exemplary process of Nd³⁺ removal via Nd³⁺-mediated AHNC bridging and precipitation. The images of Nd³⁺ solutions with concentrations ranging from 10 to 1000 ppm after AHNC (500 ppm) addition and centrifugation are shown in FIG. 9.

For the conducted experiments, NdCl₃ stock solution of 50 mM (7212 ppm of Nd³⁺) was prepared by dissolving NdCl₃·6H₂O in milli-Q water. The stock solution was further diluted for the adsorption experiments. To perform the adsorption experiments, AHNC dispersion was added to NdCl₃ solutions to form a Nd(COO)₃ complex (AHNC-Nd precipitate) at pH=5.7, removing Nd ions from solution. The supernatant was separated from AHNC-Nd precipitate by centrifugation at 4000×g for 5 min, and the Nd³⁺ equilibrium concentration in the supernatant, Cₑ, was measured using inductive couple plasma atomic emission spectroscopy (ICP-AES, Thermo iCAP 7400). The standard Nd³⁺ solution for obtaining calibration curves were prepared from a 1000 ppm stock solution, purchased from High Purity Standards (USA). The stock solution was carefully diluted to concentrations ranging from 0.05 ppm to 500 ppm, furnishing a linear calibration curve. Quality control (QC) solution (EPA Method 200.7-6 Standard Solution A) purchased from High Purity Standard was also used to make sure the measured concentrations were accurate. All adsorption experiments were performed individually in centrifuge tubes at least in triplicates. The Nd³⁺ removal percentage and the maximum Nd³⁺ removal capacity of AHNC (Ge) were calculated using equations (1) and (2), respectively, where C₀ (ppm) is the initial concentration of Nd³⁺, m (g) is the dry mass of AHNC, and V (mL) is the total solution volume:

$$Removal ( \% ) = \frac{( {C}_{0} - {C}_{e} )}{{C}_{0}} \times 100 \% \qquad ( Equation 1 )$$

$${q}_{e} = \frac{( {C}_{0} - {C}_{e} )}{m} \times V \qquad ( Equation 2 )$$

The effect of contact time on AHNC-mediated Nd³⁺ adsorption was studied via incubating 500 ppm of AHNC in an Nd³⁺ solution (C₀=200 ppm) with a total solution volume of 7 mL. Upon AHNC addition, the solutions were vortexed for varying durations, i.e., 10 s, 30 s, 1 min, and 10 min, and the mixtures were centrifuged at 4000×g for 5 min, followed by Cₑ measurement using ICP-AES.

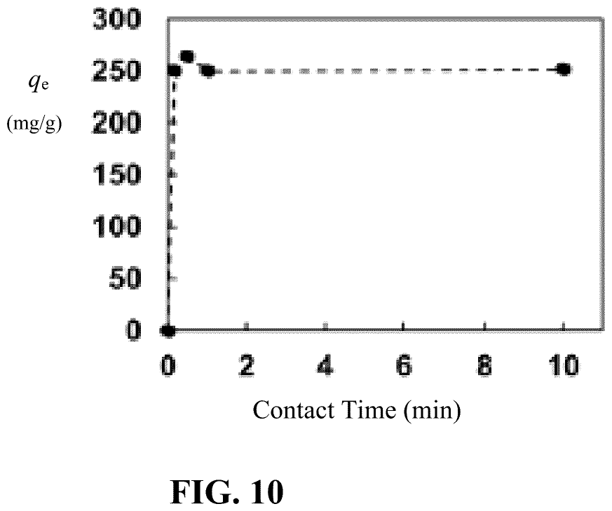

In the conducted experiments, the precipitate appeared at C₀>100 ppm, and no precipitate was observed at C₀=10 and 50 ppm. This phenomenon may be explained by the colloidal interactions in AHNC-Nd³⁺ systems. Assuming that the adsorption of Nd³⁺ to AHNC is electrostatically driven, the Nd³⁺ required to neutralize the carboxylate groups of AHNC based on the molar ratio of COO⁻:Nd³⁺ ˜3:1 is C₀˜146 ppm beyond which AHNC is completely neutralized and precipitates out. The amount of precipitated AHNC-Nd³⁺ complex can be increased by increasing Nd³⁺ concentration until AHNC is fully saturated. FIG. 10 shows the Nd³⁺ removal capacity of AHNC, qₑ, versus contact time. The adsorption of Nd³⁺ to AHNC reached equilibrium almost instantly, offering a fast and facile REE removal process. The maximum removal capacity of ˜250.3±7.4 mg/g for this experiment was achieved in this experiment in ˜10 s of contact after which no significant increase in the removal capacity was observed. We maintained the contact time ˜30 s in all the exemplary removal experiments discussed below.

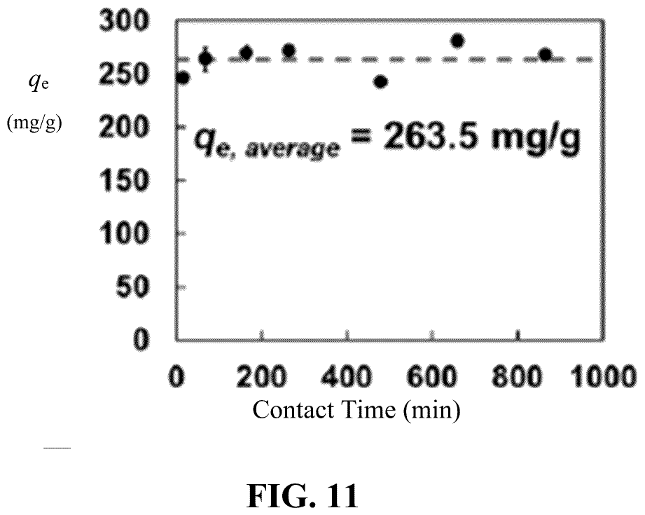

The Nd³⁺ removal capacity versus equilibrium Nd³⁺ concentration when the initial Nd³⁺ concentration was varied from ˜140 ppm to 1000 ppm is presented in FIG. 11. To generate these results, the initial Nd³⁺ concentration was varied from 10 to 1000 ppm, and 500 ppm of AHNC was added to each solution (total volume ˜7 mL), followed by vortexing for 30 s, centrifugation at 4000×g for 5 min, and Cₑ measurement using ICP-AES.

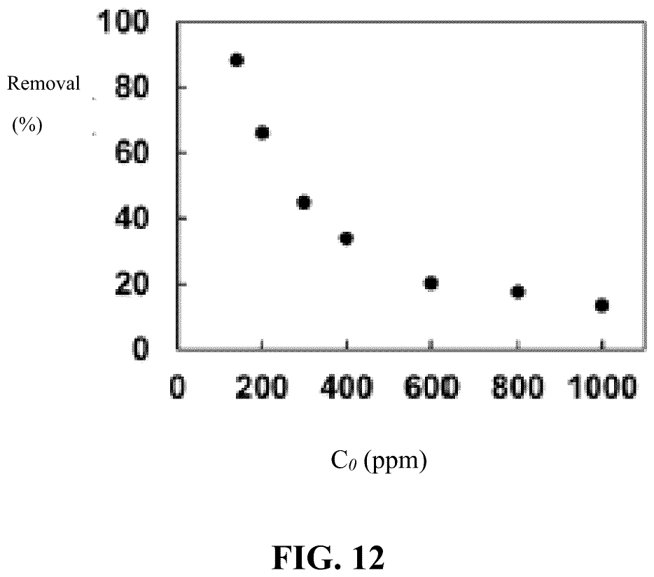

At this Nd³⁺ concentration range, the AHNC is saturated, removing an average of 263.5 mg of Nd³⁺/g±13.9 mg of Nd³⁺/g. The theoretical qₑ for this process based on the stoichiometric ratio of COO⁻:Nd³⁺ is ˜292.2 mg/g, which is close to the experimental qₑ. The Nd³⁺ removal percentage at varying initial Nd³⁺ concentrations and fixed AHNC concentration (500 ppm) is presented in FIG. 12. The maximum removal is ˜88.1% at C₀˜140 ppm and PH ˜5.7, which is followed by a decrease in the removal percentage as C₀ increases. This is due to the full saturation of active sites on AHNC, leaving the excess Nd ions in the solution. To increase the removal percentage, higher concentrations of AHNC may be used. The Nd³⁺ removal at C₀≤100 ppm is not reported due to partial aggregation and weak Nd³⁺-mediated bridging of AHNC, leaving stable, charged AHNC-Nd complexes in the solution.

### Exemplary Colloidal Behavior of AHNC During Neodymium Ion Removal

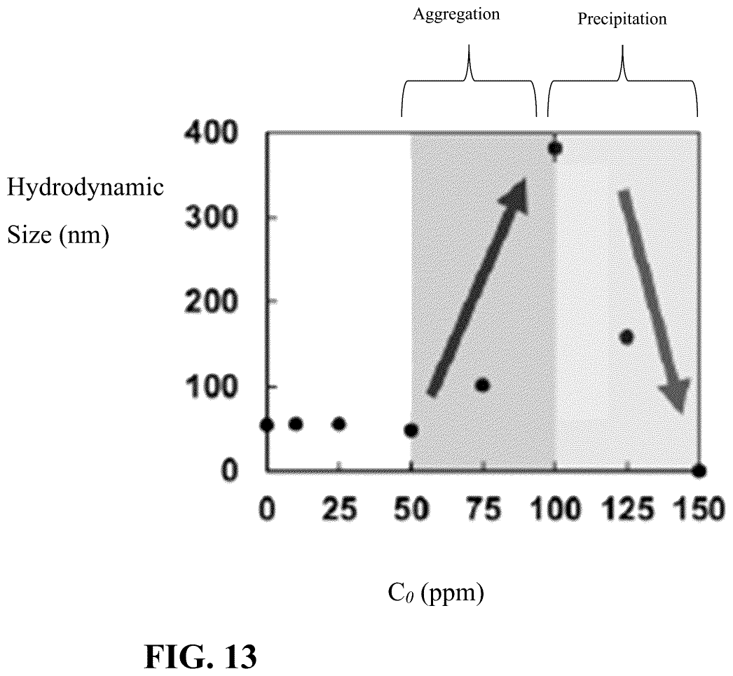

To investigate the colloidal behavior of AHNC during the Nd³⁺ adsorption process, the hydrodynamic size of AHNC-Nd aggregates in the supernatant at varying C₀ was measured (FIG. 13). The hydrodynamic size of AHNC and their aggregates after Nd³⁺ adsorption were obtained via dynamic light scattering (DLS) at 90° scattering angle and room temperature. Malvern Zetasizer Nano and a low volume quartz cuvette (ZEN2112) were used for this measurement. Before measuring the hydrodynamic size of AHNC, the concentration of AHNC dispersion was adjusted to 1000 ppm. For AHNC aggregate size measurements, the AHNC-Nd dispersions were collected from the supernatant after Nd³⁺ adsorption. The size measurements were conducted without changing the concentration of supernatant. For these experiments, the AHNC initial concentration was 500 ppm, the Nd³⁺ initial concentrations ranged from 25 to 150 ppm, and the total volume was 1.5 mL.

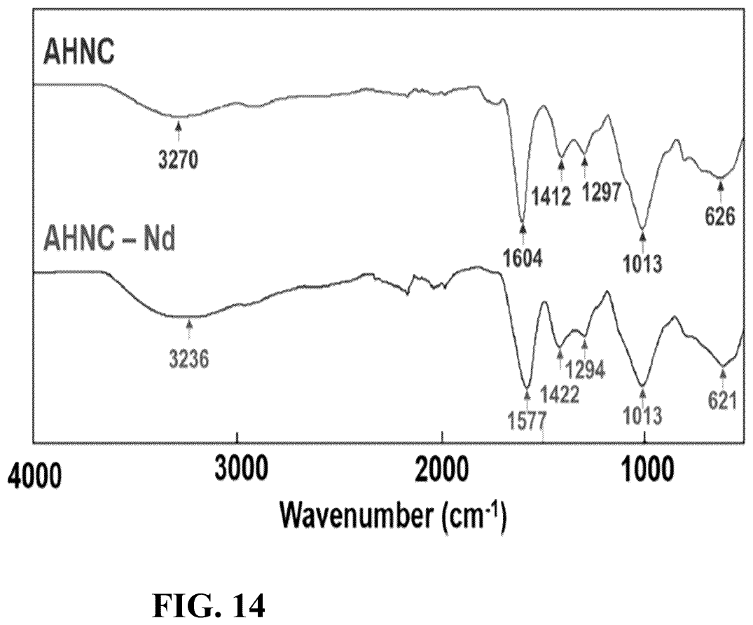

The particle size was found to remain similar to the AHNC size up to C₀˜ 50 ppm, showing that at a COO⁻:Nd³⁺ ˜ 1:9, no significant colloidal aggregation occurs. The hydrodynamic size increased at C₀>50 ppm and reached a maximum value ˜400 nm at C₀˜ 100 ppm, beyond which significant precipitation took place. The particle size at C₀˜ 125 ppm decreases because the larger particles precipitate out of the solution leaving smaller, stable aggregates in the supernatant. The measured size at C₀˜ 150 ppm reaches ˜0 as there are no more aggregates in the supernatant due to the complete saturation, aggregation, and sedimentation of AHNC. The adsorption mechanism was confirmed by Fourier transform infrared (FT-IR) spectroscopy, shown in FIG. 14.

The chemical structure of AHNC before and after Nd³⁺ adsorption was studied using FT-IR spectroscopy. Spectra were collected on a Vertex 70 spectrometer (Bruker optics, Billerica MA) equipped with a wide band mercury cadmium telluride (MCT) detector. Infrared spectra were collected in attenuated total reflection (ATR) geometry on a Diamax ATR accessory (Harrick scientific, Pleasantville, NY) with a diamond ATR crystal at a fixed incident angle of 45 degrees. AHNC samples and AHNC-Nd precipitate were dried in an oven overnight at 50° C. The solid samples were placed directly onto the ATR crystal, and maximum pressure was applied by lowering the tip of pressure clamp via a ratchet clutch mechanism calibrated to 56 ft.oz of torque. A total of 500 scans were averaged at a resolution of 6 cm⁻¹ and the absorbance was calculated by referencing to a clean ATR crystal.

In the conducted experimental work, AHNC has found to have a broad peak at ˜3270 cm⁻¹, corresponding to the stretching of —OH groups, and a peak at 1297 cm⁻¹ as a result of —OH bending vibration. The peaks at ˜1412 and ˜1013 cm⁻¹ represent-CH₂ scissor bend and CH₂—OH—CH₂ stretching, respectively.[30] The strong peak at ˜1604 cm⁻¹ is due to carboxyl (sodium form) vibration, which shifts to ˜1577 cm⁻¹ after Nd³⁺ adsorption. This carboxyl peak shift attests to the interaction between the carboxylic groups and Nd ions.

One of the persistent challenges of nanoparticle-based element removal is the lack of colloidal aggregation at low adsorbate-to-adsorbent ratios, as a result of unsaturated adsorbents, remaining stable in the solution. In such conditions, the adsorption takes place; however, the adsorbate-adsorbent species does not undergo phase separation. As may be understood from FIG. 12, it was found that Nd³⁺ cannot be completely removed from solution at low concentrations (C₀<100 ppm, COO⁻:Nd³⁺˜ 4.4:1 mol/mol) because charged AHNC-Nd aggregates remain stable in the solution.

In some experiments, we used calcium (Ca²⁺) as a complementary ion to aid in the saturation of AHNC after Nd³⁺ adsorption and facilitate the removal of AHNC-Nd aggregates. For the adsorption studies at low Nd³⁺ concentrations, e.g., C₀=10 and 50 ppm, calcium ions were used as a complementary species to bridge the otherwise unsaturated AHNC. AHNC was first added to Nd³⁺ solutions and vortexed for 30 s, followed by calcium addition and vortexing for 30 s to fully saturate AHNC. The mixtures were centrifuged at 4000×g for 5 min, and Cₑ was measured using ICP-AES. The initial concentrations of Ca²⁺ were 60, 120, and 360 ppm. The initial concentration of AHNC was 500 ppm, and the total sample volume was 7 mL.

The order of calcium ion addition can affect the ability of the calcium to aid in saturation of AHNC after Nd3 adsorption to help with the removal of AHNC-Nd aggregates. When AHNC is added to the Nd³⁺ solution first, the carboxylate groups can interact with Nd ions first, and the remaining groups can be bridged with calcium ions afterwards without significant effects on the binding of COO and Nd³⁺. This is possible because COO—Nd has about 200 times higher binding energy than COO—Ca. We hypothesize that if calcium ions are added first, they can neutralize the negative charge of AHNC, thus hinder or reduce the adsorption of Nd³⁺.

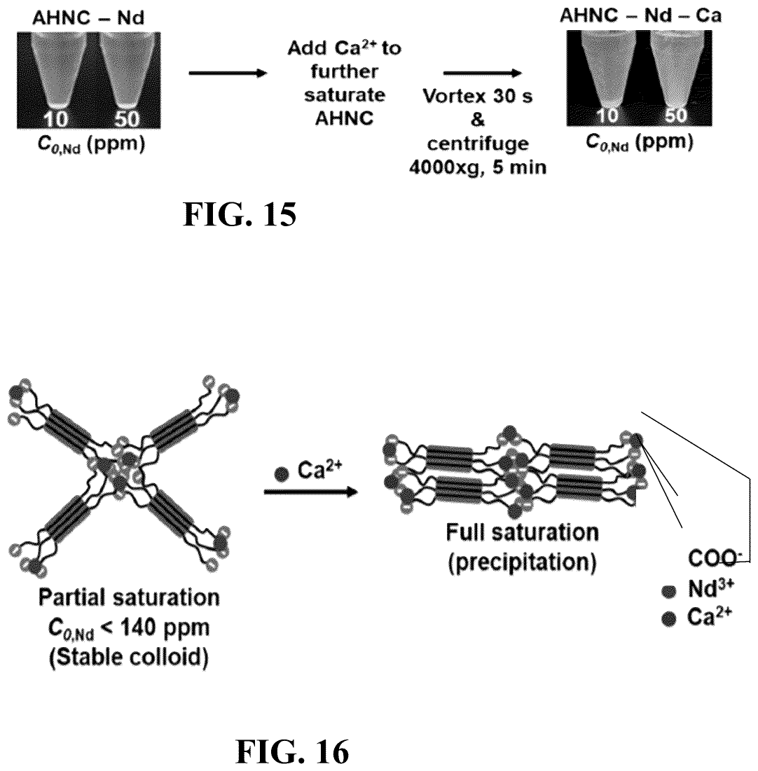

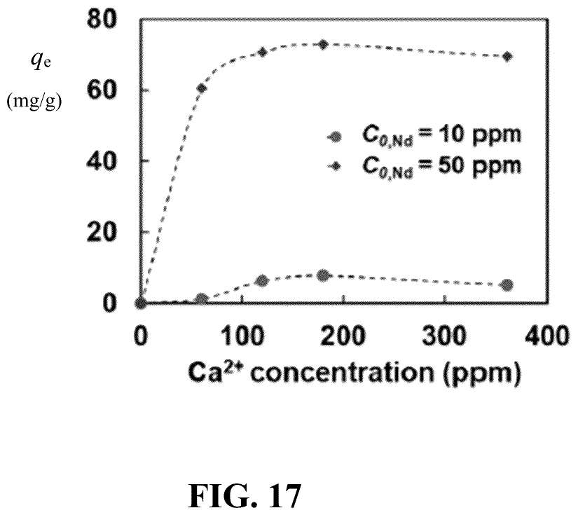

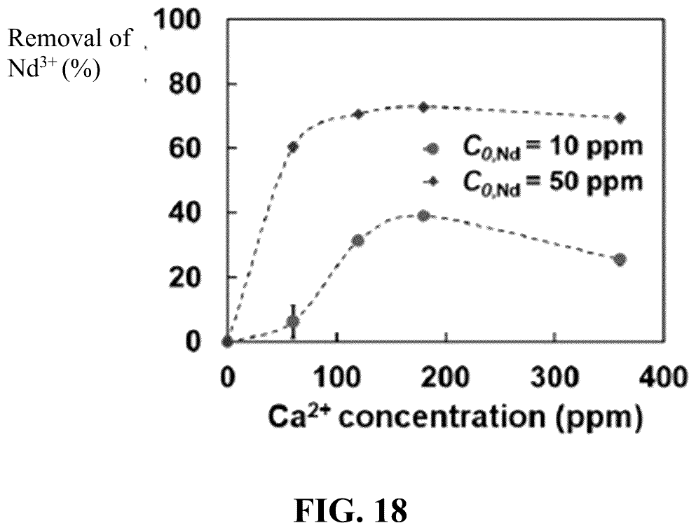

The effect of complementary Ca²⁺ on the AHNC-mediated Nd³⁺ removal was studied in experiments at initial concentrations, C₀, of C₀=10 and 50 ppm. FIG. 15 shows precipitate formation after calcium-mediated saturation of otherwise stable colloidal AHNC-Nd. The lowest calcium concentration, 60 ppm (˜ 1.50 mM) was selected based on a 1:2 molar ratio of Ca²⁺:AHNC carboxylate. In this system, before adding calcium, the Nd³⁺ concentrations were 0.07 mM (10 ppm) and 0.35 mM (50 ppm), and the carboxylate concentration was ˜3 mM. After adding calcium, the free carboxylates, ˜2.79 mM and 1.95 mM at 10 ppm and 50 ppm of Nd³⁺, respectively, form COO—Ca²⁺ complexes, undergoing partial phase separation and sedimentation, schematically shown in FIG. 16. The Nd³⁺ removal capacity and percentage of AHNC versus complementary calcium ion concentration are shown in FIGS. 17 and 18, respectively. Removal capacity and percentage increase as the calcium concentration was increased, followed by a plateau at calcium concentrations ≥120 ppm (˜ 3 mM). The maximum removal capacity is 6.3±0.1 mg/g, and 60.7±0.3 mg/g for C₀˜ 10 and 50 ppm, respectively. At a calcium concentration of 180 ppm (˜ 4.49 mM), the removal percentage at higher Nd³⁺ concentration, i.e., C₀=50 ppm reached ˜72%, and it was ˜39% for C₀=10 ppm. Interestingly, it was not possible to remove 100% of Nd ions despite using excess AHNC and calcium, showing that the lower the Nd ion concentration, the more difficult it is to fully saturate and remove the AHNC-Nd complexes, possibly as a result of steric hindrance within the entangled, shrunk hairs of AHNC. The slight decrease in the Nd³⁺ removal capacity and percentage at C₀˜ 10 ppm may be due to the partial desorption of Nd ions at high calcium ion concentrations (Ca²⁺:Nd³⁺˜ 135 mol/mol).

### Experiments Related to Ionic Strength, pH, and Temperature Effects

The ionic effects of monovalent and divalent ions on AHNC-mediated Nd³⁺ adsorption were studied using NaCl and CaCl₂) solutions, respectively. Each salt was added to 200 ppm of Nd³⁺ solution to yield the final concentrations of 1, 10, 100, 200, and 400 mM. AHNC (500 ppm) was then added to the ion-containing Nd³⁺ solutions, followed by vortexing for 30 s, centrifugation at 4000×g for 5 min, and Cₑ measurement using ICP-AES. The total solution volume was 7 mL.

The effect of pH was studied in conducted AHNC-mediated Nd³⁺ removal experiments using Nd³⁺ solutions (C₀=200 ppm) at pH ranging from 1.5 to 7, adjusted using hydrochloric acid or sodium hydroxide. AHNC (500 ppm) was added to the Nd³⁺ solutions, followed by vortexing for 30 s and centrifugation at 4000×g for 5 min. The total sample volume was 7 mL, and Cₑ was measured using ICP-AES. The pH>7 was not studied due to the formation of neodymium hydroxides.

Nd³⁺ solutions with an initial concentration of 200 ppm were prepared at temperatures ranging from 4 to 60° C. to evaluate the effect of temperature. AHNC dispersion with a concentration of 500 ppm was added to the Nd³⁺ solutions to reach a total volume of 7 mL. The mixtures were then vortexed for 30 s, their temperature was measured using a thermometer, and then centrifuged at 4000×g for 5 min, followed by measuring Cₑ using ICP-AES.

The effect of ionic strength on the Nd³⁺ removal capacity of AHNC was studied using monovalent and divalent ions, introduced to the system using NaCl and CaCl₂) solutions, respectively. In this experiment, the salt solution was added to the Nd³⁺ solution and the competitive adsorption of Na⁺ or Ca²⁺ against Nd³⁺ were investigated after adding AHNC.

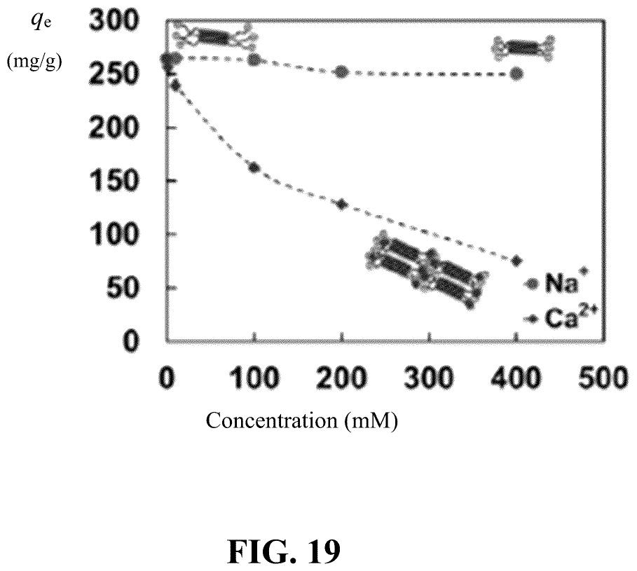

FIG. 19 shows the Nd³⁺ removal capacity of AHNC at varying Na⁺ and Ca²⁺ concentrations from our conducted experiments. The monovalent ion (Na⁺) at concentrations up to 400 mM did not have any effect on the Nd³⁺ removal capacity, despite decreasing the electrical double layer thickness. The Na⁺-mediated charge screening of dicarboxylated hairs of AHNC only results in the collapse of hairs, reducing the hydrodynamic size of the amorphous regions, without occupying the carboxylate groups. Calcium ions bridge the dicarboxylated chains (hairs) through charge neutralization, reducing the Nd³⁺ removal capacity of AHNC as the Ca²⁺ concentration increases.

Despite a high concentration of calcium ions, ranging from 0.3:1 to 0.008:1 of COO⁻:Ca²⁺ molar ratios (Ca²⁺ concentrations-10-400 mM), Nd³⁺ were still partially adsorbed and separated, showing the robustness of this adsorbent against divalent ions. In fact, only 1.52 mM of calcium ions was required to fully saturate AHNC theoretically. However, at ˜1 mM and 10 mM of Ca²⁺, the removal capacity was only reduced by ˜3% and ˜9%, respectively, compared with a calcium-free system, showing that Nd³⁺ prevails Ca²⁺ in adsorbing to COO⁻. The equilibrium competitive adsorption reactions at a constant pH>>pKₐ of carboxylates are as follows:

$${Nd}^{3 +} + {COO}^{‐} ⇌ {Nd ( COO )}_{3} \qquad Rxn . 1$$

$$C {a}^{2 +} + {COO}^{‐} ⇌ {Ca ( COO )}_{2} \qquad Rxn . 2$$

When the concentration of Ca²⁺ was increased to 100 mM (Ca²⁺:COO⁻>33:1 mol/mol), the Nd³⁺ removal capacity reached 60%, and at 400 mM (Ca²⁺:COO⁻>132:1 mol/mol), it reached 40% of the removal capacity of AHNC in a calcium-free system. These results further suggest that AHNC is selective for Nd ions at extremely high calcium ion concentrations.

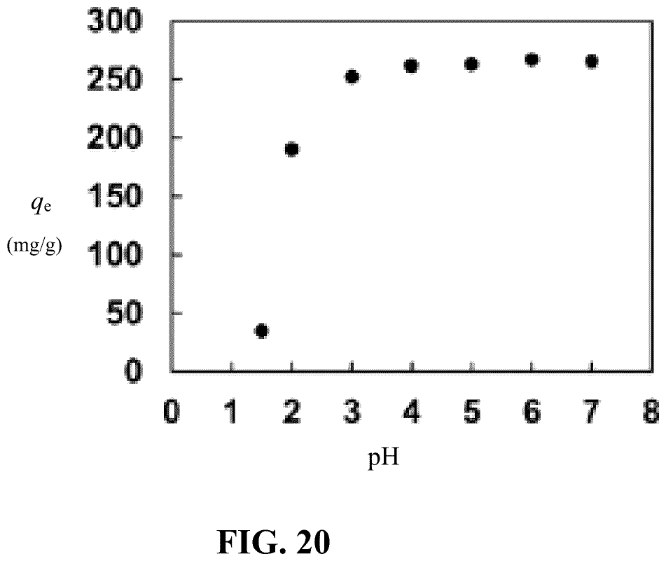

To shed light on the mechanism of Nd³⁺ adsorption, the effect of pH on the removal capacity was studied as noted above (see e.g. FIG. 20). As shown in FIG. 20, the Nd³⁺ removal at pH≥3 reached the maximum capacity of AHNC; however, the removal capacity decreased when pH was decreased below 3. The removal capacity is affected by pH when pH is lower than the pKₐ of AHNC dicarboxylates (pKₐ₁˜ 4.8 and pKₐ₂˜ 7.9, FIG. 6). The equilibrium adsorption reactions at varying pH are as follows:

$$N {d}^{3 +} + {COO}^{‐} ⇌ {Nd ( COO )}_{3} \qquad Rxn . 1$$

$$COOH ⇌ {COO}^{‐} + {H}^{+} \qquad Rxn . 3$$

$${H}_{2} O ⇌ {H}^{+} + {OH}^{‐} \qquad Rxn . 4$$

When pH was decreased, proton (H+) concentration increased, shifting Rxn. 3 to the left, protonating the carboxylate groups, which reduced the surface charge/binding sites of AHNC (Rxn. 1). At pH ˜3, only 0.6% of carboxylate groups were deprotonated, providing a theoretical removal capacity of 1.8 mg/g. At pH ˜2, 99.9% of carboxylate groups are protonated, reducing the theoretical Nd³⁺ removal capacity to 0.18 mg/g. These values are 99.2% and 99.9% lower than the experimental removal capacity for pH 3 and 2, respectively, possibly due to the high Nd³⁺ concentration, shifting Rxn. 1 to the right, reducing COO⁻ concentration, which in turn shifts Rxn. 3 to the right increasing COO concentration according to Le Chatelier's principle.

At pH ˜1.5, the removal capacity was reduced by more than 5 folds, and only 0.02% of carboxylate groups are deprotonated theoretically. These experimental results show that the electrostatic nature of Nd³⁺ adsorption to AHNC. The pH above 7 was not investigated in this study due the precipitation of neodymium hydroxide.

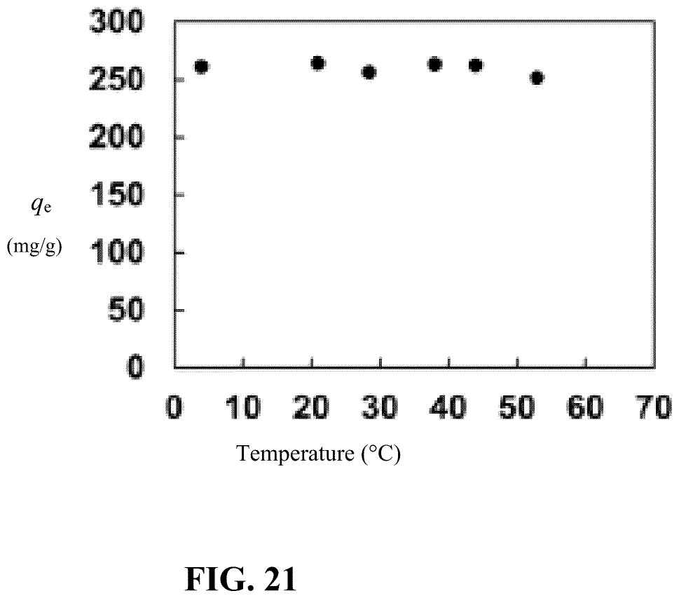

As discussed above, the adsorption of Nd³⁺ was evaluated in experiments at temperatures ranging from 4 to 53° C., the results shown in FIG. 21. As shown in FIG. 21, solution temperature did not significantly affect the adsorption of Nd³⁺.

Experiments Evaluating the Selectivity of AHNC for Nd Vs. Fe Ions

The solid waste of a NdFeB magnet is demagnetized and leached using strong acids (e.g., sulfuric acid or hydrochloric acid) to dissolve the components of the magnet, before removing Nd³⁺. Iron (Fe) can therefore be present in a number of Nd removal applications for such magnets as well as other applications. We conducted experimentation to evaluate the selectivity of a Nd³⁺ removal process is an aqueous medium including ferrous ions (Fe²⁺), mimicking the major component (˜ 58-67 wt %)[4,16] of NdFeB permanent magnets.

In these experiments, Nd³⁺ was selectively removed from Fe²⁺ solution at pH ˜3 to simulate the removal of Nd³⁺ from leached demagnetized NdFeB scrap magnet.[35] Mixtures of Nd³⁺ with different concentrations of Fe²⁺ were prepared and the solution pH was adjusted to 3 using HCl. Then, AHNC was added to the mixture, vortexed for 30 s, and the precipitate was separated using centrifugation at 4000×g for 5 minutes. Cₑ and equilibrium concentrations of Fe²⁺ were measured using ICP-AES. The initial concentration of Nd³⁺ was 200 ppm, Fe²⁺ concentrations were 200, 400, and 800 ppm, AHNC concentration was 500 ppm, and the total sample volume was 1 mL. Fe²⁺ removal capacity (q_{e,Fe}) of AHNC was also studied in the absence of Nd³⁺ using the same concentrations of Fe²⁺ and AHNC at pH=3.

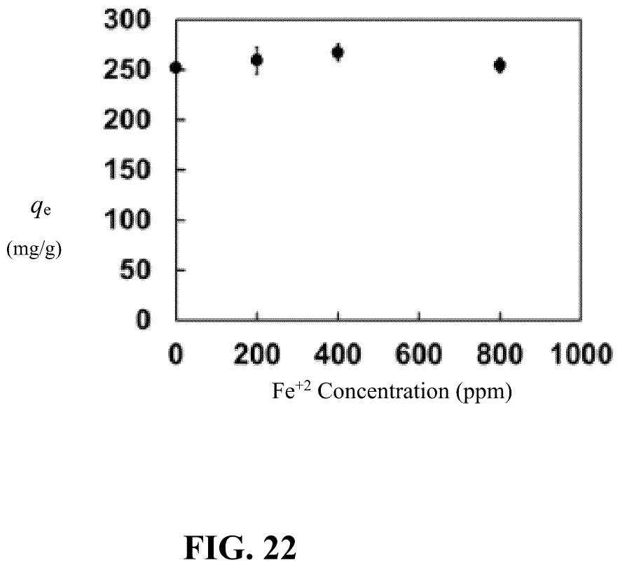

AHNC-mediated Nd³⁺ removal at varying concentrations of Fe²⁺ is presented in FIG. 22. Despite the high concentration of Fe²⁺ (up to 800 ppm, 14.3 mM) in the medium, the Nd³⁺ removal capacity of AHNC is not affected. This is possibly due to the higher binding energy (˜ 300 times) between Nd³⁺ and COO⁻ compared with Fe²⁺—COO⁻.

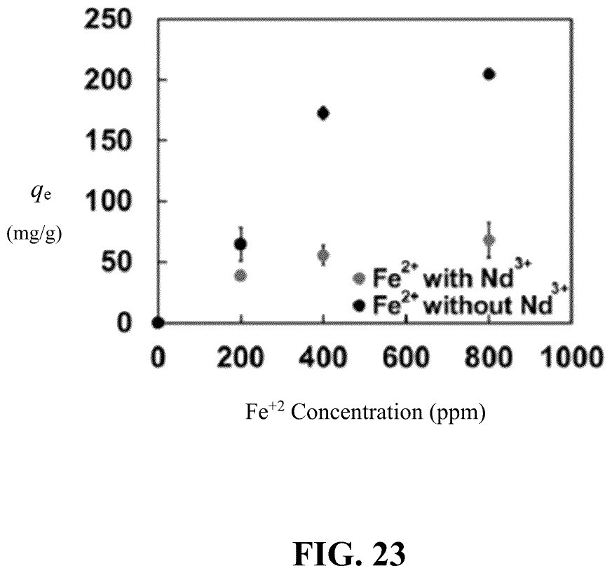

FIG. 23 shows the Fe²⁺ removal capacity (qₑ) of AHNC under the effect of Nd³⁺. When there is no Nd³⁺ in the solution, the removal capacity increases from ˜50 mg/g at Fe²⁺ concentration of 200 ppm (Fe²⁺:COO⁻˜ 1:0.8 mol/mol) to >200 mg/g at 800 ppm (Fe²⁺:COO⁻ ˜ 1:0.2 mol/mol) of Fe²⁺. When Nd³⁺ (200 ppm) is initially in the solution, the Fe²⁺ removal is significantly reduced, and remains around 50 ppm at Fe²⁺>200 ppm. This can happen because the carboxylate on AHNC is occupied by Nd³⁺, leaving fewer active sites for Fe²⁺ removal.

Table 1, provided below, presents the Nd³⁺ removal using AHNC via the exemplary processes discussed herein based on the experimental results discussed herein in comparison with various conventional adsorbents reported in the literature. The removal capacity of AHNC in embodiments of our process and apparatus is among the top adsorbents, and the adsorption time is significantly lower. Due its colloidal nature and hairy morphology, AHNC can remove Nd³⁺ at a much shorter contact time (within seconds) compared with other adsorbents (typically ranging from 0.5-72 h), which can increase the energy efficiency for separation processes. This attests to the superiority of AHNC as an advanced sustainable material for Nd³⁺ removal, which is attributed to the high charge content of AHNC and selectivity of dicarboxylated cellulose chains for Nd³⁺.

As presented in Table 1, there are a few cellulose-based adsorbents that can remove Nd³⁺, such as functionalized kenaf cellulose, i.e., hydroxamic acid and amidoxime. However, their removal performance drops by more than 50% at low pH (pH=3), and their required contact time is about 2 h. Embodiments of our process utilizing AHNC has the advantage of removing Nd³⁺ at low pH, which can be beneficial for Nd recycling from NdFeB magnets, which is mostly performed at low pH.

TABLE 1
Nd³⁺ removal using various adsorbents.

| | qₑ | | Contact | | C₀ | |
|---|---|---|---|---|---|---|
| Adsorbent | (mg/g) | pH | time | | (ppm) | Selectivity |
| Embodiments of our process using | 40-263.5 | 5.7 | 10 | s | 10-1000 | Na⁺, Ca²⁺, Fe²⁺ |
| AHNC | | | | | | |
| Magnetic nanoparticles | 25 | 5.9 | 30 | min | 7-144 | Na⁺ |
| functionalized by the | | | | | | |
| poly(aminoethylene N-methyl 1- | | | | | | |
| formic acid, 1-phosphonic acid) | | | | | | |
| Activated charcoal | 30 | N/A | 30 | min | 500-4000 | N/A |
| Hybrid alginate-silica | 57.6 | 6 | 4 | h | 288 | N/A |
| microspheres | | | | | | |
| Magnetic iron oxide particle | 22.27 | 8.22 | 2 | h | 10 | Na⁺ |
| Two lanthanides-based metal | 142.8 | 6 | 5 | min | 100-500 | Na⁺, K⁺, Mg²⁺, |
| organic framework (MOF) | | | | | | Ca²⁺ |
| Amorphous zirconium phosphate | 27.5 | 3 | 15 | h | 1.4-1440 | Co²⁺, Dy³⁺ |
| Vermiculite | 29.57 | 3.3 | 6 | h | 144-721 | Ni²⁺, Cu²⁺, Pb²⁺, |
| | | | | | | Zn²⁺ |
| Cellulose modified with thiourea | 73 | N/A | 30 | min | 10-300 | N/A |
| Kenaf cellulose modified with | 233 | 6 | 2 | h | 5-1400 | N/A |
| poly(hydroxamic acid) ligand | | | | | | |
| Kenaf cellulose modified with | 210 | 6 | 2 | h | 14,242 | N/A |
| poly(amidoxime) ligand | | | | | | |
| Phosphorous functionalized | 335.5 | 6.1 | 3 | h | 50-500 | F³⁺ |
| nanoporous carbon | | | | | | |
| Chitosan-manganese-ferrite | 44.29 | 4 | 24 | h | 5-200 | N/A |
| magnetic beads | | | | | | |
| Acrylic resin (110 Resin) | 308 | 6 | 72 | h | 167 | N/A |
| Cellulose | 34.98 | 3 | 24 | h | 10-100 | Pr³⁺, Dy³⁺, Tb³⁺, |
| nanocrystals/organosilica | | | | | | Fe³⁺ |
| composite ionic imprinted | | | | | | |
| mesoporous films | | | | | | |
| Chrysotile nanotubes | 47.44 | 7 | 16 | h | 7.1-64.3 | Na⁺ |
| Phosphorus based sol-gel | 160 | 6 | 24 | h | 1.4- [symbol] | Eu³⁺, Er³⁺, Y³⁺ |
| Calixarene-functionalized | 311.53 | 7 | 3 | h | 20-1120 | N/A |
| graphene oxide composites | | | | | | |
| Green microalgae (chlorella | 126.13 | 5 | 1.5 | h | 50-250 | Fe²⁺ |
| vulgaris) | | | | | | |
| Aminomethylphosphonic acid | 30.32 | 5 | 7 | h | N/A | U⁶⁺ |
| functionalized chitosan | | | | | | |
| {[Ce(BTC)(H₂O)]•DMF}ₙ MOF | 100 | 5.4 | 17 | h | 100-500 | N/A |
| Silica gel modified with diglycol | 16.15 | 1 | 24 | h | 29-721 | Na⁺ |
| amic acid | | | | | | |
| Chitosan-silica hybrid | 23.1 | 6 | 3 | h | 72 | Dy³⁺ |
| functionalized with | | | | | | |
| ethylenediaminetetraacetic acid | | | | | | |
| (EDTA) | | | | | | |
| Chitosan-silica hybrid | 34.6 | 6 | 2 | h | 72 | Dy³⁺ |
| functionalized | | | | | | |
| diethylenetriaminepentaacetic acid | | | | | | |
| (DTPA) | | | | | | |
| Chitosan functionalized with | 74 | 6 | 4 | h | 200 | Ho³⁺, Pr³⁺ |
| EDTA | | | | | | |
| Chitosan functionalized with | 77 | 6 | 4 | h | 200 | Ho³⁺, Pr³⁺ |
| DTPA | | | | | | |
| DNA-functionalized mesoporous | 110.4 | 3 | 2 | h | 71-504 | N/A |
| carbon | | | | | | |
| Chitosan and iron(III) hydroxide | 30.9 | 4 | 72 | h | 5-400 | B³⁺ |
| composite | | | | | | |
| Calcium alginate/carboxymethyl | 73.37 | 5.5 | 40 | min | 30-300 | Na⁺ |
| chitosan/Ni0.2Zn0.2Fe2.6O4 | | | | | | |
| magnetic bionanocomposite | | | | | | |
| Carboxymethyl chitosan entrapped | 53.04 | 6.9 | 26 | h | 21-210 | Pr³⁺ |
| by silica | | | | | | |
| Magnetic alginate microcapsules | 149.3 | 4 | 20 | h | 72-360 | Co²⁺, Zn²⁺ |
| containing the extractant 2- | | | | | | |
| ethylhexyl phosphonic acid mono- | | | | | | |
| 2-ethylhexyl ester | | | | | | |
| Activated carbon functionalized | 71.42 | 6 | 15 | min | 10-300 | Dy³⁺ |
| with EDTA | | | | | | |

[symbol]

indicates data missing or illegible when filed

### Exemplary Apparatus Embodiments

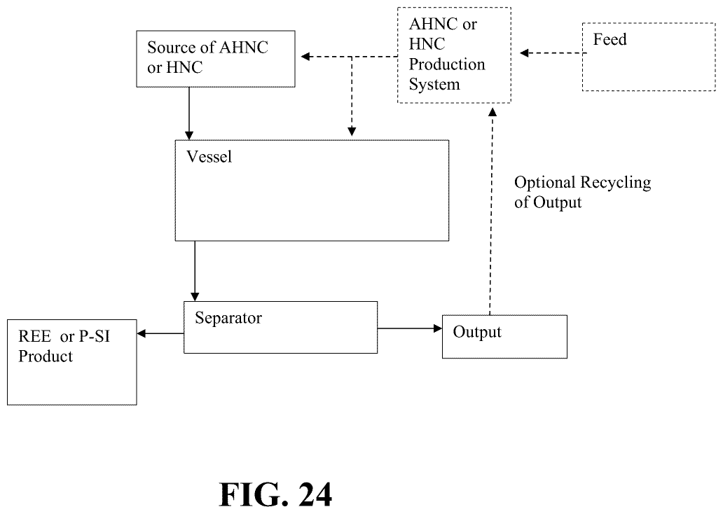

Embodiments of an apparatus for selective removal of at least one REE can be appreciated from FIG. 24 as well as the discussion of the exemplary process provided above and the experimentation and experimental results discussed above. In some embodiments, the apparatus can include a feed of source material for forming an adsorption media. The source material can include a cellulose feed (shown in broken line). The cellulose feed can be wood, pulped wood, pulp wood sheets, or other biomass-based materials that are wetted to form a wetted pulp or other slurry material.

The cellulose feed material can be fed to an AHNC production system. This system can include a reactor, a series of reactors, or other equipment to produce a DAMC intermediate from the cellulose feed material and subsequently produce AHNC from the DAMC intermediate. For example, a feed of wet pulp slurry can be mixed with NaCl and NaIO₄ and continuously stirred or agitated in a DAMC reactor vessel for a pre-selected DAMC formation period of time (e.g. 96 hours) at a pre-selected DAMC formation temperature (e.g. room temperature) in a vessel (e.g. covered tank, enclosed tank, batch reactor vessel, semi-batch reactor vessel, etc.) to prevent the light-mediated deactivation of periodate. After the pre-selected DAMC formation period of time has passed, the reaction can be stopped by addition of a reaction quenching agent to quench the unreacted periodate. (e.g. ethylene glycol can be added to quench the unreacted periodate, etc.).

The AHNC production system can be configured to facilitate washing of the formed DAMC and subsequently filter the DAMC for feeding to an AHNC conversion reactor. The AHNC conversion reactor can be configured so that the aldehyde groups of DAMC can be converted to dicarboxylate groups to form AHNC. For example, the DAMC slurry containing solid DAMC, NaCl, NaClO₂, and H₂O₂ can be output from DAMC reactor vessel and be mixed together and continuously stirred for a pre-selected AHNC formation period of time (e.g. 24 hours) at a pre-selected AHNC formation temperature (e.g. room temperature). This solution can be maintained at a pre-selected AHNC formation pH level (e.g. a pH of 5) for at least a pre-selected AHNC formation period of time (e.g. 5 hours) by the intermittent addition of NaOH into the AHNC reactor vessel during the agitation, or stirring of the solution retained therein.

Thereafter, the solution can be output from the AHNC reactor of the AHNC production system and centrifuged for a first centrifugal period of time to separate the non-disintegrated fibers. Ethanol can then added to the supernatant to precipitate AHNC, which can be separated by centrifugation at for a second centrifugal period of time. The AHNC obtained from precipitation of the AHNC can be include AHCNC and DCC. This material can then be redispersed for a pre-selected purification time period (e.g. at least 4 days, at least 5 days, more than 3 days, etc.) to remove salt and any other chemicals and subsequently fed to a vessel to provide a source of AHNC. The source of the AHNC can then be utilized to provide AHNC to a vessel for recovery of REE operations. In other embodiments, the AHNC can be directly output from a purification vessel holding tank of the AHNC production system or a purified AHNC holding tank of the AHNC production system to feed the AHNC to a vessel for REE recovery operations.

In other embodiments of the apparatus, the AHNC can be produced via a first AHNC production system from a cellulose feed and subsequently provided to a vessel of a customer to provide the source of the AHNC for their use in REE recovery operations.

Embodiments of the apparatus for recovery of at least one REE can also include an REE recovery vessel that is configured to hold a solution including at least one REE to be recovered (eg. Nd). The AHNC (or its components, e.g. anionic hairy cellulose nanocrystals (AHCNC) and solubilized dicarboxylated cellulose (DCC)) can be fed to the REE recovery vessel for adsorption of at least one REE within the solution. The AHNC or AHNC components fed therein can function as adsorption media to remove Nd or other REE retained in the REE recovery vessel. For example, the source of AHNC can include an AHNC dispersion received from the AHNC production system. The AHNC dispersion can be output form the AHNC source to the REE recovery vessel was added to form an AHNC-REE precipitate that can function to remove the REE ions from the solution as precipitated solid particulates. In other embodiments, AHNC's components can be fed to the REE recovery vessel to form the AHNC-REE precipitate.

The formed AHNC-REE precipitate within the solution can then be output from the REE recovery vessel to a separator (e.g. a centrifuge or array of centrifuges, at least one sedimentation tank, clarifier tank, clarifier, etc.) for separation of the REE containing solid precipitates from the fluid of the solution. The separator can utilize at least one centrifuge and also (or alternatively) be configured to conduct separation via other methods, such as sedimentation, adding a flocculant, etc. The liquid or gas of the fluid can be output from the separator as output for use in other processing or for waste disposal. As shown in broken line, a portion of this fluid can optionally be recycled to the AHNC production system for use there, for example. In other embodiments, the entirety of the output can be passed for waste disposal and/or utilized in other processing. The solid REE containing precipitate particulates can be output from the separator as REE product that may undergo additional processing to remove the REE from the AHNC for REE recovery and/or REE refinement.

It should be appreciated that conduits (e.g. piping, valves, etc.) can be utilized to connect the different units of the apparatus to each other. For instance, the cellulose feed can be connected to an AHNC production system via a cellulose feed conduit, the AHNC production system can be connected to the source of AHNC and/or the REE recovery vessel via at least one AHNC product output conduit, and the source of AHNC can be connected to the REE recovery vessel via an AHNC feed conduit. The REE recovery vessel can be connected to the separator via a separator feed conduit. The separator can be connected to other downstream process elements by other conduits. In some embodiments, at least one pump or compressor or other material driving mechanism can be provided to facilitate the flow of fluid or other material to different elements. An automated process control system connected to different sensors positioned for monitoring operations of the apparatus in, at or near different apparatus elements can also be utilized to help automate and control the operations of the apparatus. For example, the automated process control system can utilize a computer device connected to multiple different sensors (e.g. mass flow sensors, density sensors, temperature sensors, pressure sensors, etc.).

Embodiments of the exemplary apparatus shown in FIG. 24 can be utilized in various arrangements, plants, or facilities. For example, an embodiment of the apparatus can be utilized in magnet recycling systems, magnet waste disposal systems, e-waste disposal systems, e-waste recycling systems, acid mine drainage applications, or other applications.

Some embodiments of the apparatus shown in FIG. 24 can be configured to removal of at least one pre-selected ion (P-SI). In such embodiments, the vessel can be considered a P-SI recovery vessel that includes a solution having at least one P-SI. A source of hairy nanocellulose (HNC) can be configured to feed HNC or its components to the P-SI recovery vessel to form a solid HNC-P-SI precipitate within a fluid within the P-SI recovery vessel that includes the at least one P-SI. A separator connected to the P-SI recovery vessel can receive the fluid having the solid HNC-P-SI precipitate to separate the solid HNC-P-SI precipitate from the fluid to provide a product and other output as shown in FIG. 24. HNC can be mixed with other types of anionic, electrically neutral, or cationic functional groups and proteins engineered for selective removal of at least one P-SI in In the HNC production system that may feed HNC to the source of HNC, in the source of HNC, or in the P-SI recovery vessel to help facilitate the formation of the solid HNC-P-SI precipitate and removal of the P-SI precipitate as a product. The at last one P-SI to be recovered in such an embodiment of the apparatus can include at least one ion of Nd, Li, a rare earth element, Eu, Tb, Dy, Y, gold, silver, platinum, or a combination of two or more ions of such elements.

Embodiments of our process and apparatus for selective removal of at least one REE or P-SI can be adapted to meet a particular set of design criteria. For instance, the particular type of source material used to provide the feed, the various different agents used to form the DAMC, HNC, and/or AHNC from the source material, and the composition of the fluid having the at least one REE or at least one P-SI to be fed to an AHNC adsorbent material or HNC adsorbent material for recovery of the at least one REE or at least one P-SI can be adjusted to meet a particular set of design criteria. As another example, HNC can be mixed with other types of anionic, electrically neutral, or cationic functional groups and proteins engineered for selective removal of one or more pre-selected ions. Such ions can be Nd or can be other ions or groups of ions (e.g. lithium, an REE, precious metal, etc.).

As another example, it is contemplated that a particular feature described, either individually or as part of an embodiment, can be combined with other individually described features, or parts of other embodiments. The elements and acts of the various embodiments described herein can therefore be combined to provide further embodiments. Thus, while certain present preferred embodiments of our process, method, and apparatus for recovery of at least one REE and embodiments of methods for making and using the same have been shown and described above, it is to be distinctly understood that the invention is not limited thereto but may be otherwise variously embodied and practiced within the scope of the following claims.

1. A method for removal of at least one rare earth element (REE) comprising:
forming anionic hairy nanocellulose (AHNC) from a feed;
feeding the AHNC to a solution including the at least one REE to form solid precipitates comprising the at least one REE within the solution; and
separating the solid precipitates comprising the at least one REE from a fluid of the solution.

2. The method of claim 1, wherein the at least one REE comprises neodymium (Nd).

3. The method of claim 1, wherein the forming of AHNC from the feed comprises:
forming dialdehyde modified cellulose (DAMC) from the feed, the feed being a cellulose feed; and
forming the AHNC from the formed DAMC.

4. The method of claim 3, wherein the forming of the DAMC from the feed comprises:
mixing NaCl and NaIO₄ with a pulp feed material comprising cellulose to form a mixture and agitating the mixture for a pre-selected DAMC formation period;
adding a quenching agent to the mixture after the pre-selected DAMC formation of time.

5. The method of claim 4, wherein the quenching agent comprises ethylene glycol.

6. The method of claim 5, comprising:
washing and/or filtering the DAMC after the pre-selected DAMC formation period of time.

7. The method of claim 1, wherein the forming the AHNC from the formed DAMC comprises:
agitating a mixture of DAMC slurry having solid DAMC, milli-Q water, NaCl, NaClO₂, and H₂O₂ for a pre-selected AHNC formation period a pre-selected AHNC formation temperature.

8. The method of claim 7, wherein the mixture of DAMC slurry having solid DAMC, milli-Q water, NaCl, NaClO₂, and H₂O₂ is maintained at pH 5 for at least a pre-selected pH maintenance period of time via the intermittent addition of a base.

9. The method of claim 8, wherein the base is NaOH or any other base.

10. The method of claim 8, comprising:
separating non-disintegrated fibers from the mixture of DAMC slurry having solid DAMC, milli-Q water, NaCl, NaClO₂, and H₂O₂ after the pre-selected AHNC formation period.

11. The method of claim 10, wherein the separating of the non-disintegrated fibers from the mixture of DAMC slurry having solid DAMC, milli-Q water, NaCl, NaClO₂, and H₂O₂ includes use of at least one centrifuge.

12. The method of claim 10, comprising:
adding a precipitating agent to precipitate AHNC from the mixture of DAMC slurry having solid DAMC, milli-Q water, NaCl, NaClO₂, and H₂O₂.

13. The method of claim 12, wherein the precipitated AHNC includes anionic hairy cellulose nanocrystals (AHCNC) mixed with solubilized dicarboxylated cellulose (DCC).

14. The method of claim 13, comprising: purifying the formed AHNC for a pre-selected purification time period.

15. The method of claim 14, wherein the pre-selected purification time is at least 2 minutes or at least 1 day.

16. An apparatus for selective removal of at least one rare earth element (REE), the apparatus comprising:
an REE recovery vessel;
a source of anionic hairy nanocellulose (AHNC) configured to feed AHNC or its components to the REE recovery vessel to form a solid AHNC-REE precipitate within a fluid within the REE recovery vessel that includes the at least one REE,
a separator connected to the REE recovery vessel to receive the fluid having the solid AHNC-REE precipitate to separate the solid AHNC-REE precipitate from the fluid.

17. The apparatus of claim 16, wherein the separator comprises at least one centrifuge or be configured to perform separation via sedimentation or addition of a flocculant.

18. (canceled)

19. The apparatus of claim 16, comprising:
an AHNC production system configured to form AHNC from a feed material.

20. The apparatus of claim 19, wherein the AHNC production system is the source of AHNC or is connected to the source of AHNC for feeding AHNC to the source of AHNC.

21. An apparatus for selective removal of at least one pre-selected ion (P-SI), the apparatus comprising:
a P-SI recovery vessel;
a source of hairy nanocellulose (HNC) configured to feed HNC or its components to the P-SI recovery vessel to form a solid HNC-P-SI precipitate within a fluid within the P-SI recovery vessel that includes the at least one P-SI,
a separator connected to the P-SI recovery vessel to receive the fluid having the solid HNC-REE precipitate to separate the solid HNC-P-SI precipitate from the fluid.

22. The apparatus of claim 21, wherein the HNC is an anionic HNC (AHNC) and the apparatus also comprises an AHNC production system configured to form AHNC from a feed material.

23. The apparatus of claim 22, wherein the fed material comprises a cellulose material, a biopolymer material, chitin, chitosan, alginate, lignin, or hyaluronic acid.

24. A method for removal of at least one pre-selected ion (P-SI) comprising:
forming hairy nanocellulose (HNC) from a feed;
feeding the HNC to a solution including the at least one P-SI to form solid precipitates comprising the at least one P-SI within the solution; and
separating the solid precipitates comprising the at least one P-SI from a fluid of the solution.

25. The method of claim 24, wherein the feed comprises a cellulose material, a biopolymer material, chitin, chitosan, alginate, lignin, or hyaluronic acid.

26. The method of claim 25, comprising:
mixing anionic, electrically neutral, or cationic functional groups and/or proteins with the HINC for being added to the HNC prior to the HNC being fed to the solution for removal of the at least one P-SI.

27. The method of claim 26, wherein the at least one pre-selected ion is an ion of Nd, Li, a rare earth element, Eu, Tb, Dy, Y, gold, silver, platinum, or a combination thereof.
